(19) United States
(12) Patent Application Publication
(10) Pub. No.: US 2012/0036113 A1
(43) Pub. Date: Feb. 9, 2012

(54) PERFORMING DEDUPLICATION OF INPUT DATA AT PLURAL LEVELS

(76) Inventors: MARK DAVID LILLIBRIDGE, Mountain View, CA (US); Sean Michael Beary, Broomfield, CO (US)

(21) Appl. No.: 12/850,142

(22) Filed: Aug. 4, 2010

(51) Int. Cl. G06F 17/30

(52) U.S. Cl. 707/694; 707/E17.007

(57) ABSTRACT

Deduplication of input data is performed at a first level, where the deduplication at the first level avoids storing an additional copy of at least one of the chunks in a data store. Additional deduplication of the deduplicated input data is performed, wherein the additional deduplication further reduces duplication.

### BACKGROUND

As capabilities of computer systems have increased, the amount of data that is generated and computationally managed in enterprises (companies, educational organizations, government agencies, and so forth) has rapidly increased. Data may be in the form of emails received by employees of the enterprises, where emails can often include relatively large attachments. Moreover, computer users routinely generate large numbers of files such as text documents, multimedia presentations, and other types of data objects that have to be stored and managed.

### BRIEF DESCRIPTION OF THE DRAWINGS

Some embodiments are described with respect to the following figures:

FIG. 1 is a flow diagram of a process of performing deduplication of input data at plural levels;

FIG. 2 is a schematic diagram of a system that has deduplication modules according to some embodiments; and

FIGS. 3-6 illustrate examples of performing deduplication at multiple levels, according to some embodiments.

### DETAILED DESCRIPTION

In an enterprise, such as a company, an educational organization, a government agency, and so forth, the amount of data stored can be relatively large. To improve efficiency, deduplication of data can be performed to avoid or reduce repeated storage of common portions of data in a data store. In some implementations, deduplication of data can be accomplished by partitioning each data object into non-overlapping chunks, where a “chunk” refers to a piece of data partitioned from the data object, and where the data object can be in the form of a file or other type of data object. Examples of data objects include documents, image files, video files, audio files, backups, or any other collection or sequence of data. Upon receiving an input data object, the input data object is divided into chunks by applying a chunking technique. Note that if a data object is sufficiently small, the chunking technique may produce just one chunk.

By dividing each data object into chunks, a system is able to identify chunks that are shared by more than one data object or occur multiple times in the same data object, such that these shared chunks are stored just once in the data store to avoid or reduce the likelihood of storing duplicate data.

One of the issues associated with using chunk-based deduplication is fragmentation of data. Fragmentation refers to the issue of chunks associated with a particular data object being stored in disparate locations of a data store. For enhanced deduplication, each chunk is (ideally) stored only once and thus is located in just one location of the data store but yet can appear in multiple data objects. This leads to increased fragmentation where chunks of a data object are scattered across a storage media, which can cause read-back of data from the data store to be relatively slow. If the data store is implemented with a disk-based storage device, when a data object is being read back, the chunks of the data object may be scattered across the surface of disk media of the disk-based storage device. This scattering of chunks across the disk media of the disk-based storage device can result in multiple seeks to retrieve the scattered chunks, which can lead to slow read-back operation.

Increased compaction by using chunk-based deduplication may thus lead to increased restore times. In some examples, input data that is to be stored in a data store is in the context of a data backup system, where data to be stored in the data backup system is copied from one or multiple other systems. Should a failure occur at the one or more other systems, the backup data stored in the data backup system can be restored. A high degree of compaction using chunk-based deduplication may result in an unacceptably slow restore speed when attempting to restore backup data from the data backup system.

Restore speed can be improved with reduced compaction by allowing some of the chunks to be duplicated. Allowing duplicated copies of chunks may improve restore speeds when attempting to retrieve chunks for restoring data.

In accordance with some embodiments, the tradeoff between fast restore speeds and high compaction can be flexibly specified based on goals of an enterprise. Such goals can be reflected in predefined policies that can be used for determining the level of deduplication applied to a particular set of data. For example, a predefined policy can specify that a data set is to be initially deduplicated at a first level. The predefined policy can further specify that at a later point in time (which can be a predefined specified time after deduplication of the data set at the first level), deduplication at a second level is to be performed, where the second level of deduplication is different from the first level of deduplication. Some policies can further specify additional different levels of deduplication at additional different points in time.

A predefined policy can specify that increasing levels of deduplication are performed over time. In the context of data backup systems, for example, more recent backup data is usually more frequently accessed than older backup data (those backup data created further back in time). Thus, in accordance with some implementations, deduplication for the more recent data can be set to be at a lower level than deduplication for older data. Setting a lower level of deduplication for the more recent data means that there is less compaction for the more recent data; however, setting a higher level of deduplication for the older data means that there is a higher level of compaction for the older data. Since there is less compaction for the more recent data, the restore speed to retrieve the more recent data can be improved. At the same time, for the older data, more compaction is achieved such that storage space consumption is reduced. As the backup data ages, however, the predefined policy can specify that the deduplication applied to the backup data increases to achieve increased compaction as the backup data ages (and thus is less likely to be accessed).

Other predefined policies can specify that different sets of data are set to be deduplicated at different initial levels. In some examples, the predefined policies can also specify that the progressive change in deduplication levels for each of the different sets of data occur at different time points (in other words, policies can specify how quickly and in which direction data sets may move between different stages of deduplication). For example, a first predefined policy can specify that the initial deduplication level of the first set of data is at a first level, and that over time (at specified time intervals), increasing (or decreasing) levels of deduplication are applied. A second predefined policy (or alternatively the first predefined policy) can specify that the initial deduplication level of a second set of data is at a second level (different from the first level). The first or second predefined policy can further specify that over time (at specified time intervals that may or may not be different from the specified time intervals for the first set of data), increasing (or decreasing) levels of deduplication are applied.

In further examples, the different sets of data can be sets of data on different machines or in different logical volumes (where a “logical volume” refers to a logical partition of data).

Thus policy(ies) can specify that particular data sets, such as those from a particular machine or volume, be treated as “optimized for space”—such data sets can be deduplicated at a high level. Other data sets may be treated as “optimized for performance,” in which case such data sets would be deduplicated at a relatively low level.

As yet other examples, policy(ies) can also specify that different levels of deduplication are performed for data sets stored in different types of formats (e.g., stored on tape storage versus stored on disk-based storage). In other examples, policy(ies) can specify different levels of deduplication for different sources of data.

More generally, systems or techniques are provided to allow for the specification of different levels of deduplication for any given input set of data. For example, at a first time, a first level of deduplication can be specified for the input set of data. However, at a later time (that is some specified amount of time, as defined by a policy, after performing the deduplication at a first level), a second level of deduplication can be specified for the input set of data, where the second level can be greater (or less) than the first level such that increased (or decreased) deduplication of the input set of data is achieved. Effectively, multiple stages of deduplication are provided for any given input set of data, where each stage provides a different level of deduplication for the input set of data, and where the different stages of deduplication for the given input set of data can be performed at different specified times (as specified by a predefined policy) to achieve different deduplication levels at the different specified times.

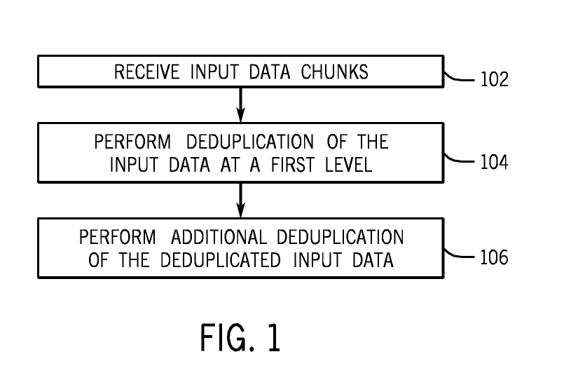

FIG. 1 is a flow diagram of a process for performing deduplication at multiple levels, according to some implementations. A system receives (at 102) input data chunks. The chunks were produced by dividing input data into chunks for storing in a data store. The dividing of input data into chunks can be performed by the receiving system, or by another system. Input data (or input data chunks) can be received by the system from an external data source or from multiple external data sources. Alternatively, input data can be created within the system and divided into chunks.

The system then performs (at 104) deduplication of the input data at a first level, where the deduplication at the first level avoids storing an additional copy of at least one of the chunks in the data store. Next, the system performs (at 106) additional deduplication of the deduplicated input data, where the additional deduplication removes a duplicate copy of one of the chunks of the deduplicated input data.

It is noted that the results (referred to herein as “results A”) of performing the additional deduplication (106) of the deduplicated input data after performance of the deduplication of the input data (104) are substantially equivalent to results (referred to herein as “results B”) that would have been obtained if the input data would have been deduplicated at a second level that provides different deduplication of the input data than the deduplication at the first level. Results A are “substantially equivalent” to results B if the space savings achieved by deduplication provided by results A are within some predefined threshold of space savings of deduplication provided by results B. The predefined threshold can be 5% (or alternatively, 2% or any other example threshold). Assume an example threshold of 5%, and assume that the space savings achieved by deduplication in results A (the results produced after the deduplication at 106 in FIG. 1) is 30%. If the space savings in results B (results obtained if the input data would have been deduplicated at a second level that provides different deduplication of the input data than the deduplication at the first level) is 31%, then results A and results B are substantially equivalent since the space savings of 30% and 31% are within 5% of each other.

Another way to determine whether results A and results B are substantially equivalent can be based on comparing numbers of extra copies of input data chunks in corresponding results A and B. If the numbers of extra copies of input data chunks in corresponding results A and B are within some predefined threshold percentage (e.g., 5%, 2%, or other value), then results A and B are considered substantially equivalent.

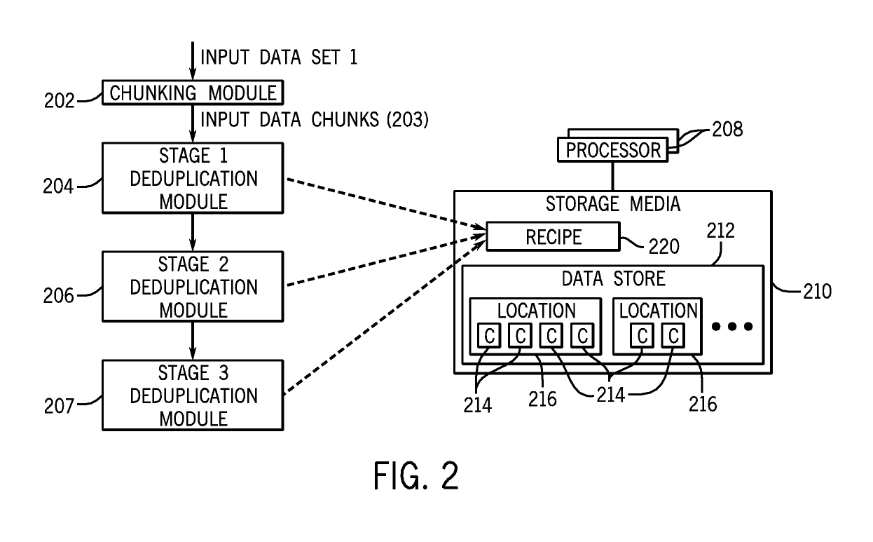

FIG. 2 is a schematic diagram of an example system according to some implementations. Input data (labeled “input data set 1”) is provided into a chunking module 202. The chunking module 202 produces input data chunks (203) from input data set 1, based on application of a chunking technique. Examples of chunking techniques are described in Athicha Muthitacharoen et al., “A Low-Bandwidth Network File System,” Proceedings of the 18th (ACM) Symposium on Operating Systems Principles, pp. 174-187 (2001), and in U.S. Pat. No. 7,269,689.

In alternative implementations, the chunking module 202 can be located in a separate system to perform the chunking of input data into chunks.

The input data chunks 203 are provided by the chunking module 202 to a stage 1 deduplication module 204, which applies deduplication of the input data chunks at a first level. The stage 1 deduplication module 204 generates a recipe 220, which is a data structure that keeps track of where the chunks corresponding to input data set 1 are located in a data store 212. The recipe 220 can store chunk references that point to locations of respective chunks in the data store 212. A chunk reference is a value that provides an indication of a location of a corresponding chunk. For example, the chunk reference can be in the form of a pointer (to a location), a hash value (that provides an indication of a location), an address, or some other location indication. The chunk reference can point or otherwise refer to a storage region or a logical storage structure that is able to store multiple chunks. Alternatively, the chunk reference can point or otherwise refer to just an individual chunk.

As depicted in FIG. 2, the recipe 220 and the data store 212 are stored in storage media 210, which can be implemented with non-persistent and/or persistent storage media. The data store 212 also contains chunks 214, which are chunks of input data received by the system of FIG. 2 and stored in the data store 212.

As depicted in FIG. 2, the data store 212 has multiple locations 216 in which the chunks 214 are stored. A “location” of a data store in which a chunk is stored refers to a storage structure (logical or physical) that is able to store one or multiple chunks. Thus, multiple locations refer to multiple storage structures. In some implementations, the locations are implemented in the form of chunk containers (or more simply “containers”), where each container is a logical data structure of a data store for storing one or multiple chunks. A container can be implemented as a discrete file or object. In alternative implementations, instead of using discrete containers to store respective chunks, a continuous storage area can be defined that is divided into a number of regions, where each region is able to store respective one or multiple chunks. Thus, a region of a continuous storage area is also another type of “location” 216 as depicted in FIG. 2.

The system of FIG. 2 also includes a stage 2 deduplication module 206, which applies a second level of deduplication on the deduplicated input data resulting from the stage 1 deduplication module 206. The stage 2 deduplication module 206 can be invoked at a later, specified point in time after the stage 1 deduplication module 204 has deduplicated the input data set 1. The deduplication of the second level as performed by the stage 2 deduplication module 206 can be a higher level of deduplication in which a greater amount of deduplication is performed. In other words, the deduplication at the second level is able to reduce the number of duplicates of the input data chunks 203 stored in data store 212 as compared to the deduplication at the first level as performed by the stage 1 deduplication module 204. In this manner, the stage 2 deduplication module 206 is able to perform a higher level of compaction on the input data chunks 203.

There can be additional deduplication modules (e.g., stage 3 deduplication module 207) that apply correspondingly increasing levels of deduplication (in other words, these latter stage deduplication modules are able to perform even greater deduplication than the stage 2 deduplication module 206).

The chunking module 202, stage 1 deduplication module 204, stage 2 deduplication module 206, and so forth, can be implemented as machine-readable instructions executable on one or multiple processors 208, which is (are) connected to the storage media 210.

The stage 2 deduplication module 206 updates the recipe 220 (due to further deduplication performed by the stage 2 deduplication module 206). Because the stage 2 deduplication module 206 has performed further deduplication to remove at least one duplicate chunk from the deduplicated input data produced by the stage 1 deduplication module 206, the recipe 220 is updated so it no longer has any chunk references to the removed at least one duplicate chunk. Those references are changed to point to a different location in the data store 212 that contains another copy of the chunk corresponding to the removed duplicate chunk that existed before input data set 1 was received.

In alternative implementations, instead of updating the recipe 220, a new version of the recipe 220 can be created by the stage 2 deduplication module 206, while the recipe created by the stage 1 deduplication module 204 is removed.

The input data set 1 depicted in FIG. 2 can be part of a stream of input data. In some implementations, it is noted that multiple streams of input data can be processed in parallel by the system of FIG. 2. More generally, reference is made to “input data,” which refers to some amount of data that has been received for storage in a data store. In some examples, the data store can be part of a backup storage system to store backup copies of data. In other implementations, the data store can be part of an archival storage system, or more generally, can be part of any storage system or other type of computing system or electronic device.

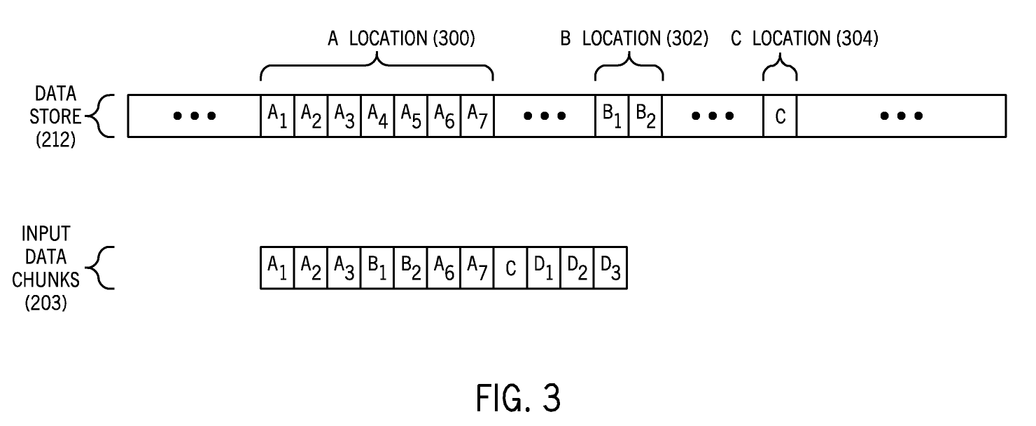

FIG. 3 shows example content of the data store 212 and the input data chunks 203 (as output by the chunking module 202) of FIG. 2. The data store 212 includes multiple locations, including an A location 300, a B location 302, and a C location 304, among other locations in the data store 212. The A location 300, B location 302, and C location 304 store existing copies of chunks that were previously received from other input data stream(s). The A location 300 includes chunks A₁, A₂, A₃, A₄, A₅, A₆, and A₇; the B location 302 contains chunks B₁ and B₂; and the C location 304 contains chunk C.

The input data chunks 203 include chunks A₁, A₂, A₃, chunks B₁ and B₂, chunks A₆ and A₇, chunk C, and chunks D₁, D₂, and D₃. Note that of the input data chunks 203 in the FIG. 3 example, only chunks D₁, D₂, and D₃ are new while existing copies already exist for the other input data chunks (A₁, A₂, A₃, B₁, B₂, A₆, A₇, and C). Maximum deduplication would specify that only the new chunks D₁, D₂, and D₃ would be added to the data store 212, while the other chunks A₁, A₂, A₃, B₁, B₂, A₆, A₇, and C of the input data chunks 203 are not added to the data store 212, since copies of such chunks already exist. However, as noted above, such maximum compaction may not be desirable under certain conditions, since maximum compaction may lead to increased restore times.

As a result, initially, a lower level of deduplication may be performed on the input data chunks 203. Deduplication at an initial, first level is performed by the stage 1 deduplication module 204, and later (after some specified time interval, as defined by policy, has passed from performance of deduplication at the first level), deduplication at different, higher levels can be performed by corresponding later stage deduplication modules.

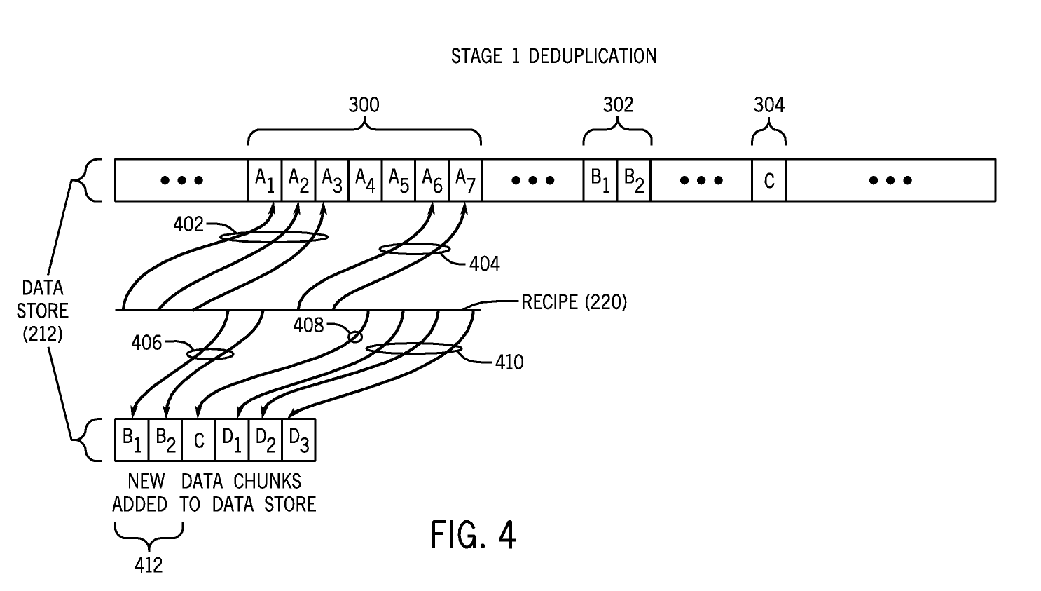

FIG. 4 shows an example of the recipe 220 produced by the stage 1 deduplication module 204 (for the FIG. 3 example data store 212 and input data chunks 203) according to some implementations. In such implementations, with the deduplication at the first level, only one of the locations 300, 302, and 304 may be used by the stage 1 deduplication module 204 as a chunk reference target. In other words, the stage 1 deduplication module 204 uses only one location for generating chunk references to copies of chunks already present in the data store 212 for the input data chunks. The stage 1 deduplication module 204 chooses to use the location which has the most copies of the input data chunks 203. In this example, this is the A location 300, which has copies of five of the input data chunks 203, namely A₁, A₂, A₃, A₆, and A₇. The other locations, by contrast, have copies of only two and one of the input data chunks 203, respectively.

The stage 1 deduplication module 204 does not use locations 302 and 304 when generating recipe 220. The stage 1 deduplication module 204 therefore is able to generate chunk references to existing copies for input data chunks A₁, A₂, A₃, A₆, and A₇ (see input data chunks 203 in FIG. 3) in the data store 212 in the A location 300. As a result, the recipe 220 produced by the stage 1 deduplication module 204 contains chunk references (402, 404) to existing chunks A₁, A₂, A₃, A₆, and A₇ in the A location 300. Chunks A₁, A₂, A₃, A₆, and A₇ of the input data chunks 203 are thus not stored again in the data store 212, which avoids duplication of input chunks A₁, A₂, A₃, A₆, and A₇.

However, since only one of the locations in the data store is considered for generating chunk references, the stage 1 deduplication module 204 does not generate chunk references to the existing copies of B₁, B₂, and C in the data store 212.

As a result, chunks references 406, 408, and 410 are provided in the recipe 220 that point to new copies of chunks B₁, B₂, C, D₁, D₂, and D₃ added to the data store 212. This operation results in duplicates of chunks B₁, B₂, and C being added to the data store 212, in addition to the copies of chunks B₁, B₂, and C in locations 302 and 304, respectively, that are already present in the data store 212.

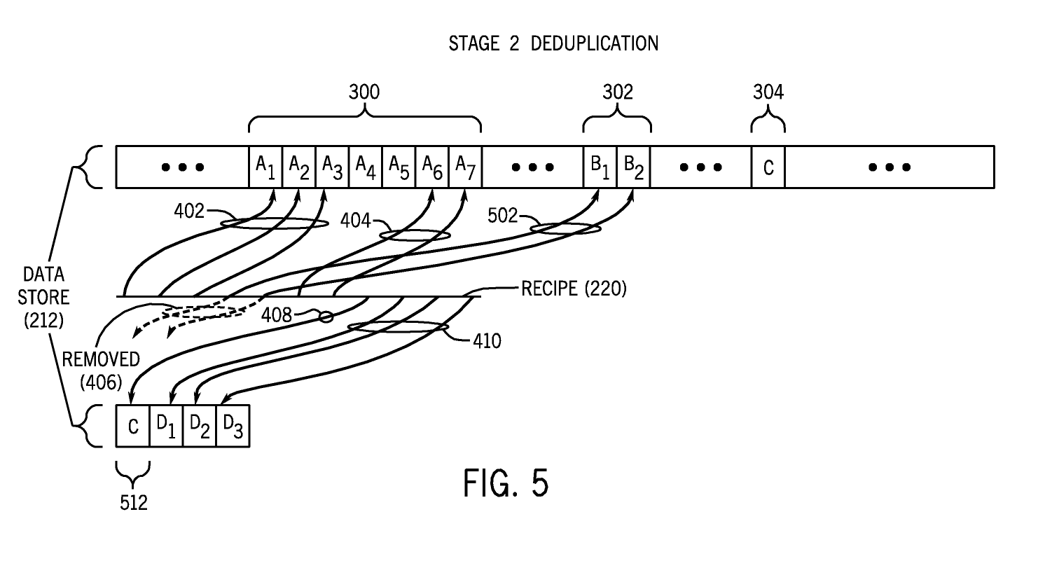

In these examples, only a small amount of input data chunks are shown, and thus the number of locations that may be used is effectively fixed for a given deduplication level. With larger amounts of data, the number of locations that may be used is proportional to the amount of input data. For example, for a first level of deduplication, one location may be permitted per 10 MB (or other predefined amount) of input data, and for a second level of deduplication, two locations may be permitted per 10 MB (or other predefined amount) of input data. At a later point in time (after some specified interval), it may be desirable to perform deduplication at a second level for the input data set 1, such as by the stage 2 deduplication module 206 of FIG. 2. The stage 2 deduplication module 206 uses two locations (e.g., 300 and 302) of the data store 212 for generating chunk references to existing chunks already present in the data store 212 for input data chunks 203. Since the stage 2 deduplication module 206 uses both the A and B locations 300 and 302 (these are the two locations with the most copies of the input data chunks 203), the stage 2 deduplication module 206 can further generate chunk references to the existing copies of chunks B₁ and B₂ in the data store 212. As a result, the stage 2 deduplication module 206 updates the recipe 220 to cause the chunk references 406 to be modified to become chunk references 502 in FIG. 5. Chunk references 502 point to chunks B₁ and B₂ in the B location 302. The duplicate copies of chunks B₁ and B₂ (412 in FIG. 4) that were added by the stage 1 deduplication module 204 to the data store 212 can be removed, to achieve enhanced compaction. Note, however, that even with the deduplication at the second level, there is still some amount of duplication, since chunk C is duplicated (512 and 304 in FIG. 5) in the data store 212.

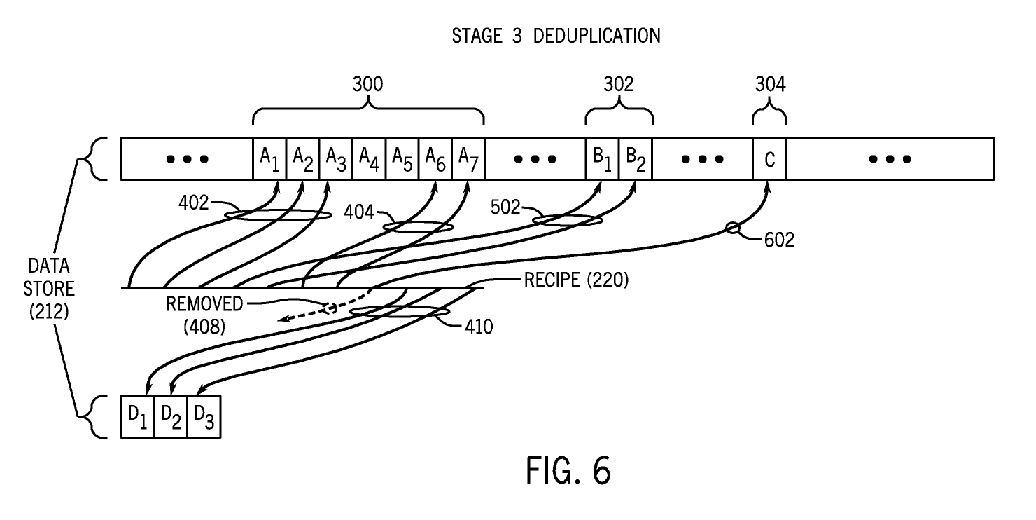

At yet a further later point in time (after another specified time interval), deduplication at a third level may be desired, which causes a latter stage 3 deduplication module 207 to be invoked (after the stage 2 deduplication module 206). The stage 3 deduplication module 207 uses at most three locations in the data store 212 when generating chunk references to existing copies of chunks in the data store 212. In this case, the stage 3 deduplication module 207 uses locations 300, 302, and 304, which means that the stage 3 deduplication module 207 is able to generate chunk references to existing copies of chunks A₁, A₂, A₃, B₁, B₂, A₆, A₇, and C in the data store 212. As a result, the recipe 220 is updated to change chunk reference 408 (FIGS. 4 and 5) to chunk reference 602 (FIG. 6) that points to a copy of chunk C in the C location 304. The duplicate copy of chunk C (512) can be removed from the data store 212, to provide enhanced compaction as compared to the state of the data store 212 in the FIG. 5 example.

If there are more input data chunks, deduplication at higher levels can be further performed to further reduce duplication.

The number of locations in the data store 212 used by a deduplication module (204, 206, or 207) is dependent in some implementations upon a predefined parameter, referred to as a “capping parameter.” The recipe 220 produced by a corresponding deduplication module is effectively an assignment of input data chunks to locations of the data store 212. If the capping parameter has a value 1, then the number of locations of the data store 212 to which the input data chunks 203 can be assigned would be 1 (plus an “open” container). The open container is a specially designated container in which new input data chunks not known to be related to any previous chunks are placed. Such chunks are placed in this open container until the open container becomes full—at that point, the open container is closed and a new empty open container is created. Note that when the data store 212 is empty, most input data chunks will be of this kind. In some implementations, there is one open container per input stream of data being processed, with the unrelated chunks of a given stream being placed in its associated open container.

If the capped parameter has a value 2, then the number of locations to which the input data chunks 203 are assigned cannot exceed 2, plus the open container.

Further details regarding assignment of chunks to locations, such as containers, of the data store based on using of capping parameters, are provided in U.S. Ser. No. 12/759,174, filed Apr. 13, 2010.

In other implementations, rather than using a capping parameter, other parameters are used for specifying the number of locations to be used by a deduplication module in generating chunk references to copies of chunks that are already in the data store.

In some implementations, for applying additional deduplication by latter stage deduplication modules (e.g., any deduplication module after the stage 1 deduplication module 204), receipt of the input data chunks is simulated based on the recipe (e.g., 220 in FIG. 2). In other words, the recipe 220 as produced by a previous stage deduplication module is replayed to simulate the ingestion of input data. By replaying the recipe 220, receipt of input data chunks is simulated. Further deduplication performed by a latter stage deduplication module (e.g., 206 or 207 in FIG. 2) is based on the simulated input data chunks replayed from the recipe 220.

As discussed above, performing deduplication of input data by the stage 1 deduplication module 204 (FIG. 1) is based on using a capping parameter set at a first value. A subsequent additional deduplication of the deduplicated input data performed by the stage 2 deduplication module 206 is performed by simulating deduplication of the simulated input data chunks based on setting the capping parameter to a second value.

In other implementations, the simulation of receipt of input data by replaying a recipe may be run more efficiently or avoided entirely by using saved information from an earlier stage's computations.

A latter stage deduplication module effectively changes chunk references to chunk copies located in the previous stage's open (possibly since closed) location(s) for a given input data set to chunk references to chunk copies located in other previously existing locations. The first chunk copies each now usually have one fewer reference pointing to them; usually this means that they are no longer referenced by any recipe. If so, then they may be removed. This removal can be performed immediately, or upon later garbage collection. Garbage collection refers to removal of chunk copies that are no longer referenced from locations in the data store for reducing sizes of corresponding locations. The removal of a chunk copy from a particular location may also involve leaving a forwarding pointer behind in the location. The forwarding pointer is provided to allow for a subsequent requestor that attempts to access the reassigned chunk to find the reassigned chunk in the new location.

In some implementations, the process of deduplication at successive different levels can be run in reverse. In other words, following deduplication at a higher level, deduplication at a lower level can be performed at a later point in time. Again, the ingestion of the recipe is performed, with a lower capping parameter specified to cause less assignment of chunks to previous locations, resulting in more duplicate copies of input data chunks 203.

As noted above, the chunking module 202 and deduplication modules 204, 206, and 207 of FIG. 2 can be implemented with machine-readable instructions that are loaded for execution on processor(s) 208. A processor can include a microprocessor, microcontroller, processor module or subsystem, programmable integrated circuit, programmable gate array, or another control or computing device.

Data and instructions are stored in respective storage devices, which are implemented as one or more computer-readable or machine-readable storage media. The storage media include different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components.

In the foregoing description, numerous details are set forth to provide an understanding of the subject disclosed herein. However, implementations may be practiced without some or all of these details. Other implementations may include modifications and variations from the details discussed above. It is intended that the appended claims cover such modifications and variations.

What is claimed is:

1. A method comprising:
receiving, by a system having a processor, input data chunks for storing in a data store, wherein the input data chunks were divided from input data;
performing, by the system, deduplication of the input data at a first level, wherein the deduplication at the first level avoids storing an additional copy of at least one of the chunks in the data store; and
performing, by the system, additional deduplication of the deduplicated input data, wherein the additional deduplication removes a duplicate copy of one of the chunks of the deduplicated input data.

2. The method of claim 1, wherein performing the additional deduplication is in response to a triggering event identified in a predefined policy.

3. The method of claim 1, wherein performing the additional deduplication occurs a specified amount of time after performing the deduplication of the input data, wherein the specified amount of time is provided by a predefined policy.

4. The method of claim 1, wherein results of performing the additional deduplication of the deduplicated input data after performance of the deduplication of the input data are substantially equivalent to results that would have been obtained if the input data would have been deduplicated at a second level that provides different deduplication of the input data than the deduplication at the first level.

5. The method of claim 1, further comprising:
specifying, for first input data, that deduplication of the first input data is to be started at the first level; and
specifying, for second input data, that deduplication of the second input data is to be started at a second level that provides greater deduplication of input data than the deduplication at the first level.

6. The method of claim 1, wherein performing the deduplication at the first level is based on setting a capping parameter at a first value, and wherein performing the additional deduplication of the deduplicated input data is based on setting the capping parameter at a second, different value, wherein the capping parameter specifies a maximum number of locations of the data store to use for assigning the input data chunks.

7. The method of claim 1, further comprising:
producing, as a result of the deduplication at the first level, a recipe that has chunk references to locations in the data store; and
modifying, as a result of the deduplication of the deduplicated input data, at least one of the chunk references in the recipe.

8. The method of claim 7, further comprising:
simulating receipt of the input data chunks using the recipe,
wherein performing the additional deduplication of the deduplicated input data is based on the simulated input data chunks.

9. The method of claim 8, wherein performing the deduplication of the input data at the first level is based on setting a parameter to a first value, and
wherein performing the additional deduplication of the deduplicated input data comprises performing simulated deduplication of the simulated input data chunks based on setting the parameter to a second value.

10. The method of claim 1, further comprising:
performing further deduplication of the additionally deduplicated input data, wherein the further deduplication removes a duplicate copy of one of the chunks of the additionally deduplicated input data.

11. The method of claim 1, wherein performing the deduplication of the input data at the first level is according to a predefined policy that varies the first level based on a machine on which the input data is located or based on a volume in which the input data is located.

12. The method of claim 1, wherein performing the deduplication of the input data at the first level is according to a predefined policy that varies the first level based on a format used to store the input data.

13. An article comprising at least one computer-readable storage medium storing instructions that upon execution cause a computer to:
receive chunks divided from input data to store into a data store;
determine, in response to a predefined policy, a particular level at which the input data is to be deduplicated;
deduplicate the input data according to the particular level, wherein the deduplication at the particular level avoids storing an additional copy of at least one of the chunks in the data store; and
perform additional deduplication of the deduplicated input data, wherein the additional deduplication removes a duplicate copy of a corresponding one of the chunks of the deduplicated input data

14. The article of claim 13, wherein the predefined policy specifies a relative timing between deduplicating the input data and performing the additional deduplication.

15. The article of claim 13, wherein the predefined policy specifies plural levels of deduplication from which selection is made based on at least one criterion, wherein determining, in response to the predefined policy, the particular level at which the input data is to be deduplicated comprises obtaining information associated with the input data for selecting from among the plural levels to use as the particular level.

16. The article of claim 15, wherein the at least one criterion includes one or multiple of: a criterion relating to a physical location of the input data; a criterion relating to a logical volume in which the input data is located; a criterion relating to a time or date at which the deduplication is to be performed; a criterion relating to a source of the input data; and a criterion relating to a format in which the input data is stored.

17. A system comprising:
a storage media to store a data store;
at least one processor; and
a plurality of deduplication modules executable on the at least one processor,
wherein a first of the plurality of deduplication modules is to receive input data chunks and to apply first deduplication to the input data chunks to produce first deduplicated data to reduce duplication of data chunks, and
wherein a second of the plurality of deduplication modules is apply second deduplication to the first deduplicated data to further reduce duplication of data chunks.

18. The system of claim 17, wherein the data store has a plurality of locations to store chunks, wherein the first deduplication module is to use fewer of the plurality of locations as chunk reference targets in generating chunk references to copies of chunks already present in the data store for the input data chunks than the second deduplication module.

19. The system of claim 17, wherein the second deduplication module is invoked to apply the second deduplication a specified time interval after the first deduplication has performed the first deduplication, wherein the specified time interval is defined by a policy.
